(19) United States
(12) Patent Application Publication
(10) Pub. No.: US 2008/0255826 A1
(43) Pub. Date: Oct. 16, 2008

(54) Dictionary data generating apparatus, character input apparatus, dictionary data generating method, and character input method

(75) Inventor: Akimitsu Hio, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/082,759

(22) Filed: Apr. 14, 2008

(30) Foreign Application Priority Data
Apr. 16, 2007 (JP) P2007-106981

(51) Int. Cl. G06F 17/21

(52) U.S. Cl. 704/10

(57) ABSTRACT

A dictionary data generating apparatus is disclosed. The apparatus includes: an acquiring part configured to acquire a current issue keyword from inputted information including a current issue keyword; and a generating part configured to generate current issue dictionary data for prediction conversion based on the current issue keyword acquired by the acquiring part.

### CROSS REFERENCES TO RELATED APPLICATIONS

The present invention contains subject matter related to Japanese Patent Application JP 2007-106981 filed in the Japanese Patent Office on Apr. 16, 2007, the entire contents of which being incorporated herein by reference.

### BACKGROUND OF THE INVENTION

1. Field of the Invention

The present invention relates to a dictionary data generating apparatus, a character input apparatus, a dictionary data generating method, and a character input method, particularly to prediction conversion in inputting characters.

2. Description of the Related Art

Generally, in appliances that are various electronic appliances such as a mobile telephone, an electronic dictionary, and a personal computer, to which a user can input characters, many of them have a prediction conversion function in inputting characters.

The prediction conversion function is a function that when a user starts inputting a part of characters in a certain word or phrase, a word desired to enter by the user is predicted from an inputted character (or a plurality of inputted characters) to show one or a plurality of conversion candidates for allowing the user to select one. In the case in which the user finds a word desired to enter among the words of the conversion candidates, the user can select and enter the word.

In order to implement the prediction conversion function, prediction conversion dictionary data is provided in an appliance. A prediction conversion dictionary is dictionary data in which a character string to be a conversion candidate is registered as corresponding to inputted characters (hereinafter, referred to as “a conversion candidate character string”). For example, for an input character [symbol] (a hiragana character represented by input of) A”, conversion candidate character strings are registered such as [symbol] (a word of a kanji character and a hiragana character represented by input of) AU (fit in English)”, [symbol] (a word of a kanji character and a hiragana character represented by input of) AU (meet in English)”, and [symbol] (a word of a kanji character represented by input of) AI (love in English)”. When a user inputs a character, the appliance references to the prediction conversion dictionary to show conversion candidate character strings.

For example, in the case in which a user desires to enter a word [symbol] (a ward of kanji characters represented by input of) YOSOKU (prediction in English)”, the user inputs only the beginning character [symbol] (a hiragana character represented by input of) YO” to show conversion candidate character strings such as, [symbol] YOSOKU”, and [symbol] (a word of kanji characters represented by input of) YOSOU (expectation in English)” on the screen. Then, it is sufficient for the user to select “ [symbol] YOSOKU” from the shown conversion candidate character strings, whereby efficient character input can be conducted.

In addition, generally, a learning process is also conducted for prediction conversion dictionary data. The learning process is a process that a conversion candidate character string selected by a user and a character string frequently inputted are put on the higher priority of the order for conversion candidates. Alternatively, characters that are not listed in the conversion candidates and inputted by the user are added to conversion candidates.

It is well known that the learning process like this allows a more improved character input efficiency. Such appliances with a small number of input keys, which have no alphabet keys in particular, enjoy a great improvement of character input efficiency achieved by the prediction conversion function.

### SUMMARY OF THE INVENTION

In various practical appliances, such characters are often inputted that are words or phrases other than general words or phrases registered in a prediction conversion dictionary. Naturally, all of the characters of a character string not registered in the prediction conversion dictionary have to be inputted by a user, which does not exert the effect of an improved conversion efficiency through prediction conversion.

For example, one example is considered that a staff of a television broadcast station goes to report news. In this case, for video data files taken by a camera person, titles and brief comments corresponding to the report contents are inputted into text on site. For instance, the names of people who are interviewed and the locations of the reports, news titles and so on are inputted by characters to an imaging apparatus, and are linked to video files.

In this case, people's names and words used in news titles are often related to current issues. In other words, many of them are proper nouns and words not registered in the prediction conversion dictionary. On this account, a character string desired to enter is not shown as a conversion candidate, which causes efforts for input. Particularly, in consideration of the circumstances that many cameras used for reports and pieces of equipment used on site do not have alphabet keys for character input, inputting characters becomes very complicated. In addition, also in consideration of the circumstances that quickness is desired on report sites, intense demand is the improvement of character input efficiency.

It is desirable to allow efficient input of words of current issues, which are no conversion candidates in general, in inputting characters.

A dictionary data generating apparatus according to an embodiment of the invention is a dictionary data generating apparatus including: an acquiring part configured to acquire a current issue keyword from inputted information including a current issue keyword; and a generating part configured to generate current issue dictionary data for prediction conversion based on the current issue keyword acquired by the acquiring part.

In addition, the acquiring part may acquire a current issue keyword for every genre from the inputted information, and the generating part may generate the current issue dictionary data from the current issue keyword for every genre.

In addition, the generating part may combine the current issue dictionary data with standard dictionary data that is generated based on a standard word to generate practical dictionary data for prediction conversion.

In addition, a character input apparatus according to an embodiment of the invention is a character input apparatus including: a conversion candidate acquiring part configured to reference to practical dictionary data for prediction conversion including a current issue keyword to acquire one or a plurality of conversion candidate character strings in response to a character input; a presenting part configured to present a conversion candidate character string acquired by the conversion candidate acquiring part; and an input confirmation processing part configured to confirm an input character string from a conversion candidate character string presented by the presenting part in response to manipulation input.

A dictionary data generating method according to an embodiment of the invention is a dictionary data generating method including the steps of: acquiring a current issue keyword from inputted information including a current issue keyword; and generating current issue dictionary data for prediction conversion based on an acquired current issue keyword.

In addition, in the dictionary data generating method according to the embodiment of the invention, the current issue dictionary data may be combined with standard dictionary data that is generated based on a standard word to generate the practical dictionary data for prediction conversion.

In addition, a character input method according to an embodiment of the invention is a character input method including the steps of: referencing to practical dictionary data for prediction conversion including a current issue keyword to acquire one or a plurality of conversion candidate character strings in response to a character input; presenting the acquired conversion candidate character string; and confirming an input character string from the presented conversion candidate character string in response to manipulation input.

In the embodiment of the invention described above, a current issue keyword is acquired from inputted information to generate current issue dictionary data based on the acquired keyword. In other words, it is current issue dictionary data in which a word of current issues is registered as a conversion candidate character string.

In addition, in the embodiment of the invention, current issue dictionary data having a current issue keyword is combined with standard dictionary data in which a general word is registered to generate practical dictionary data for prediction conversion. Practical dictionary data here is dictionary data that is actually used for prediction conversion in input.

In addition, in the embodiment of the invention, in the case in which a character is inputted, character strings as conversion candidates are presented from dictionary data for prediction conversion including current issue keywords, and a user is allowed to select one from the conversion candidates. A dictionary for prediction conversion here is the current issue dictionary data or the practical dictionary data.

According to the embodiment of the invention, current issue dictionary data is generated in which a character string as a current issue keyword is registered. In addition, current issue dictionary data is combined with standard dictionary data to generate practical dictionary data. The current issue dictionary data and the practical dictionary data are used in the character input apparatus, whereby in the character input apparatus, a character string as a current issue keyword can be inputted through prediction conversion.

Accordingly, it can be intended to improve the character input efficiency of the words of current issues, which is significantly preferable in an apparatus having many opportunities inputting the words of current issues.

### BRIEF DESCRIPTION OF THE DRAWINGS

FIG. 1 is a view showing a system configuration according to an embodiment of the invention;

FIG. 2 is a block diagram depicting a terminal according to the embodiment;

FIG. 3 is a block diagram depicting an imaging apparatus according to the embodiment;

FIG. 4 is a view showing an exemplary RDF file according to the embodiment;

FIG. 5 is a view showing a flow chart depicting a current issue dictionary data generation process according to the embodiment;

FIG. 6 is a view showing current issue dictionary data according to the embodiment;

FIG. 7 is a view showing practical dictionary data according to the embodiment;

FIG. 8 is a view showing a flow chart depicting a practical dictionary data generation process according to the embodiment;

FIG. 9 is a view showing a flow chart depicting a character input process according to the embodiment; and

FIGS. 10A to 10D are views showing a learning process according to the embodiment.

### DETAILED DESCRIPTION OF THE INVENTION

Hereinafter, an embodiment of the invention will be described in the following order.
1. The system configuration according to the embodiment
2. Exemplary configurations of the terminal and the imaging apparatus
3. A current issue dictionary data generation process
4. A practical dictionary data generation process
5. A character input process
6. Advantages and modifications according to the embodiment

### 1. THE SYSTEM CONFIGURATION ACCORDING TO THE EMBODIMENT

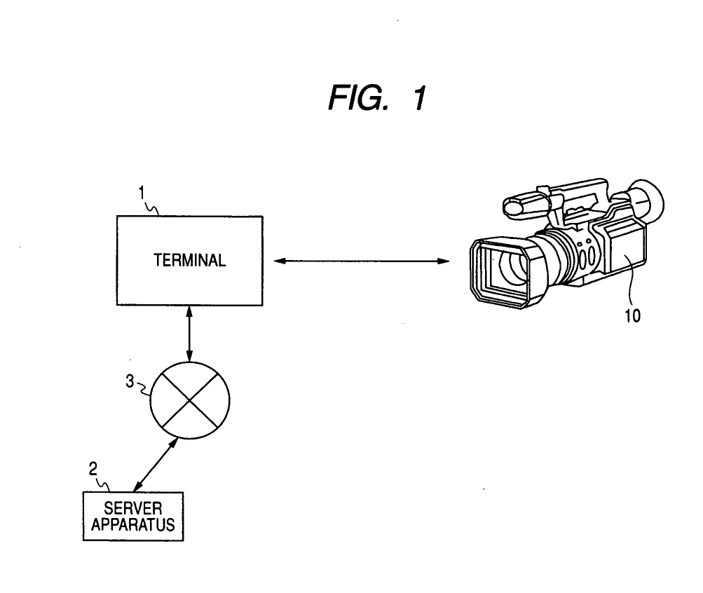

In the embodiment, a system configuration shown in FIG. 1 will be taken and described as an example.

In addition, in this example, for dictionary data for prediction conversion, three types of dictionary data, standard dictionary data, current issue dictionary data, and practical dictionary data, will be discussed.

The standard dictionary data is dictionary data in which words generally used in prediction conversion are registered as conversion candidate character strings as standard words, the data particularly not including the words of current issues and proper nouns.

The current issue dictionary data is dictionary data in which the words of current issues and proper nouns are registered as conversion candidate character strings, the dictionary data being a feature of the embodiment of the invention.

The practical dictionary data is dictionary data in which the standard dictionary data is combined with the current issue dictionary data, which is dictionary data used in actual prediction conversion.

FIG. 1 shows a terminal 1, an imaging apparatus 10, and a server apparatus 2. For example, the terminal 1 is a computer terminal of a television broadcast station. In addition, for example, the imaging apparatus 10 is a camera used for imaging in reporting by report staff.

Here, discussions will proceed in accordance with an example that the terminal 1 corresponds to a dictionary generating apparatus according to the embodiment of the invention (a dictionary generating apparatus that generates current issue dictionary data). Moreover, discussions will proceed in accordance with an example that the imaging apparatus 10 corresponds to a dictionary generating apparatus according to the embodiment of the invention (a dictionary generating apparatus that generates practical dictionary data), and to a character input apparatus.

In the case shown in FIG. 1, the terminal 1 can acquire information from the server apparatus 2 over a network 3.

The server apparatus 2 is configured as an information distribution server and a web server. Particularly, in this example, it is sufficient that the server apparatus 2 is an apparatus that can offer news information to the terminal 1 in the form of data distribution, data broadcasting, or web access from the terminal 1.

For the network 3, the Internet, a LAN (Local Area Network), a mobile telephone communication network, a PHS communication network, and an ad hoc network can be considered.

In this system, the terminal 1 acquires news data from the server apparatus 2. For example, news data such as politics, economics, entertainment, and sports is acquired.

Then, in the terminal 1, current issue keywords are extracted from news data to generate current issue dictionary data in which the extracted character strings are registered as conversion candidate character strings.

The current issue dictionary data is passed to the imaging apparatus 10. The imaging apparatus 10 has a character input function that text data as titles and comments is added to imaged video files, in addition to the imaging function. Moreover, in inputting characters, the imaging apparatus 10 has a prediction conversion function that dictionary data for prediction conversion is used to present conversion candidate character strings.

For example, in the imaging apparatus 10, current issue dictionary data is acquired from the terminal 1 through schemes such as cable or wireless communications with the terminal 1, or exchange of the data on a portable recording medium.

For instance, in the broadcast station, current issue dictionary data is generated in the terminal 1 in the regular basis such as everyday or every week, and this current issue dictionary data is offered to the imaging apparatus 10 used for reporting.

In the imaging apparatus 10, the current issue dictionary data is acquired, and then the current issue dictionary data is combined with standard dictionary data provided in the imaging apparatus 10 to generate practical dictionary data. Then, in the case of inputting characters, this practical dictionary data is used for a prediction conversion process.

In addition, although described later as modifications, it may be possible that the imaging apparatus 10 or the other electronic appliances are a dictionary generating apparatus that generates current issue dictionary data, or the terminal 1 or the other electronic appliances are a dictionary generating apparatus that generates practical dictionary data or a character input apparatus.

### 2. EXEMPLARY CONFIGURATIONS OF THE TERMINAL AND THE IMAGING APPARATUS

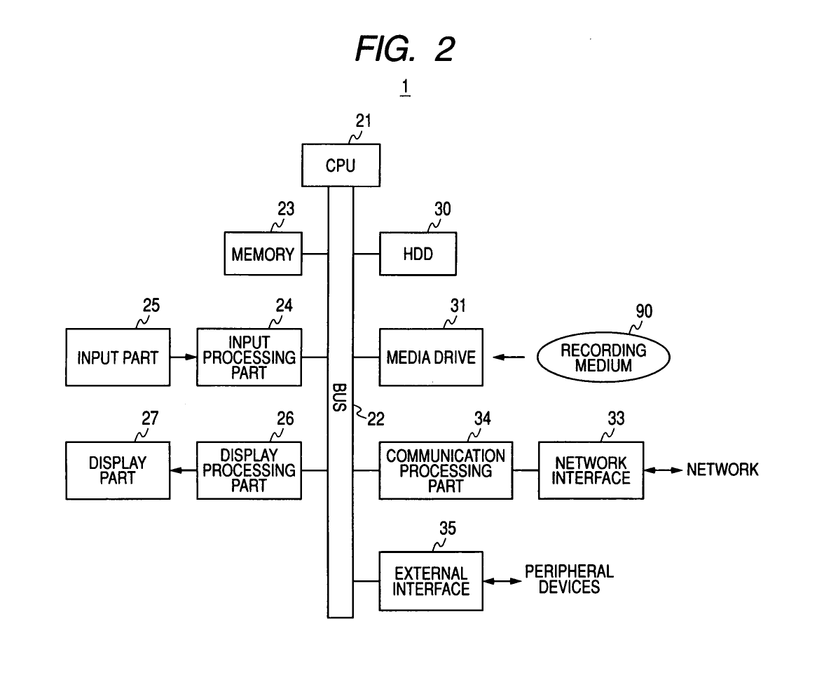

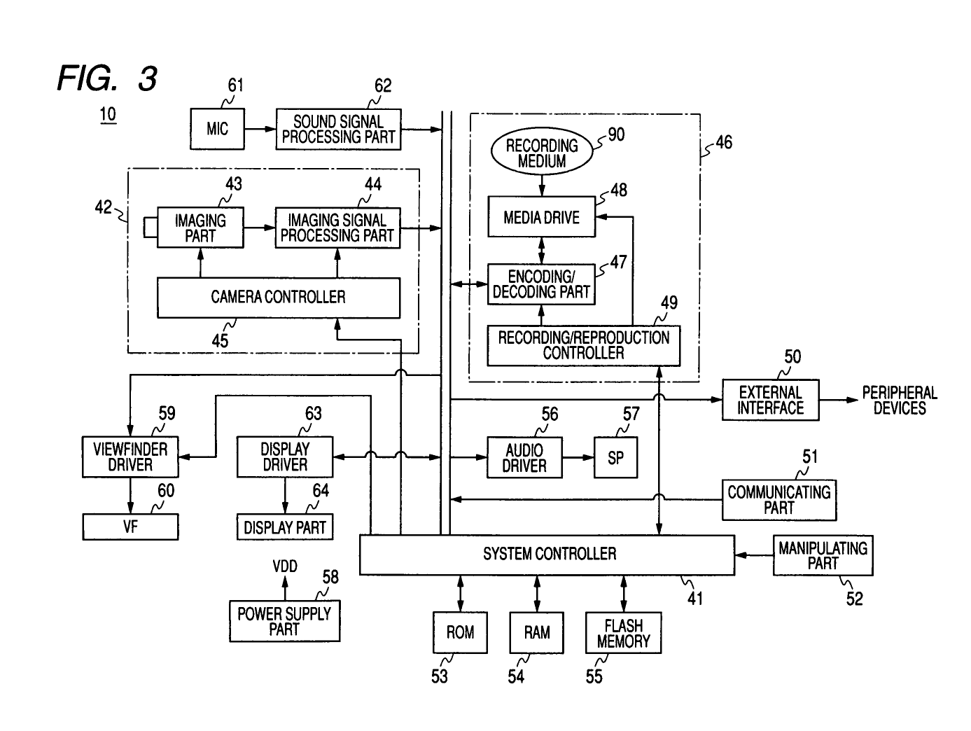

Exemplary configurations of the terminal 1 and the imaging apparatus 10 will be described with reference to FIGS. 2 and 3.

First, FIG. 2 shows an exemplary configuration of the terminal 1 shown in FIG. 1.

In FIG. 2, a CPU 21 performs control and computing processes of the individual blocks based on an activated program. For example, it performs input/output operations to an operator, memory control, HDD (hard disk drive) control, communication operations over a network, external interface control, the recording/reproduction control of a recording medium 90, and data computation.

The CPU 21 exchanges control signals and data with the individual circuit blocks through a bus 22.

A memory 23 generally shows a RAM, a ROM, and a flash memory used by the CPU 21 for processing.

The ROM in the memory 23 stores therein the operation program of the CPU 21 and a program loader. The flash memory in the memory 23 stores therein various arithmetic coefficients and parameters used in the program. The RAM in the memory 23 temporarily holds a data area and a task area allocated for running the program.

An input part 25 is an input device such as a keyboard, a mouse, a touch panel, a remote commander, and a scanner, to which an operator inputs various manipulation entries or data entries. Inputted information is subjected to a predetermined process in an input processing part 24, and is transmitted to the CPU 21 as manipulations or data entries. The CPU 21 performs necessary computations and control in accordance with the inputted information.

A display part 27 is a display device such as a liquid crystal panel, which displays thereon various items of information to the operator.

The CPU 21 supplies display information to a display processing part 26 in accordance with various operation states and input states, and then the display processing part 26 allows the display part 27 to perform the display operation based on the supplied display data.

A HDD (Hard Disk Drive) 30 is used for storing various programs and various other items of data and for the area to take inputted information.

A communication processing part 34 encodes transmission data and decodes received data based on control done by the CPU 21.

A network interface 33 sends transmission data encoded in the communication processing part 34 to other devices over the network 3. In addition, it passes signals sent from external devices over the network 3 to the communication processing part 34.

The communication processing part 34 forwards the received information to the CPU 21.

The operations of the network interface 33 and the communication processing part 34 allow news data to be acquired from the server apparatus 2 shown in FIG. 1.

A media drive 31 records and reproduces data on the portable recording medium 90. For the recording medium 90, a memory card having an optical disk or a flash memory incorporated therein can be considered.

An external interface 35 is connected to peripheral devices that are connected in accordance with the systems of IEEE 1394, USB, and SCSI, for example, for data communication. Alternatively, the external interface 35 may be configured to perform wireless communications with external devices in accordance with an infrared interface or a Bluetooth communication system.

For example, the terminal 1 can supply data (current issue dictionary data) to the imaging apparatus 10 through communications done by the external interface 35.

Alternatively, in the case in which the media drive 31 records current issue dictionary data on the recording medium 90, the recording medium 90 is mounted on the imaging apparatus 10 to reproduce the data, whereby the imaging apparatus 10 is allowed to read the current issue dictionary data.

Next, FIG. 3 shows an exemplary configuration of the imaging apparatus 10 that is used when pictures are taken in reporting, for example.

A system controller 41 is configured of a microcomputer, which controls the overall imaging apparatus 10. More specifically, it controls the operations of the individual blocks, described below.

A camera part 42 is a block for imaging video, having an imaging part 43, an imaging signal processing part 44, and a camera controller 45.

The imaging part 43 has a lens system configured of an imaging lens and a diaphragm, a drive system to allow the lens system to do the focusing operation and the zooming operation, and a CCD (Charge Coupled Device) sensor array or CMOS (Complementary Metal Oxide Semiconductor) sensor array as an imaging device that detects image lights obtained through the lens system for photoelectric conversion to generate imaging signals.

The imaging signal processing part 44 has a sample hold/AGC (Automatic Gain Control) circuit that applies gain adjustment and waveform shaping to signals obtained by the imaging device of the imaging part 43, a video A/D converter, and a digital signal processing circuit, which generates digital video data by imaging pictures.

The camera controller 45 controls the operations of the imaging part 43 and the imaging signal processing part 44 based on instructions from the system controller 41. For example, for the imaging part 43, the camera controller 45 is considered to perform control (motor control) for the operations of auto-focusing, auto exposure adjustment, aperture adjustment and zooming.

In addition, the camera controller 45 has a timing generator, which controls the signal processing operation of the imaging device and the sample hold/AGC circuit and the video A/D converter of the imaging signal processing part 44 in accordance with timing signals generated in the timing generator.

With the configuration above, the camera part 42 generates imaged video data.

In addition, sound signals obtained by a microphone 61 are subjected to A/D conversion in a sound signal processing part 62 to generate sound data in synchronization with the imaged video data.

A recording/reproducing part 46 is a block that can record the imaged video data obtained in the camera part 42 (and sound data obtained by the microphone 61) on the recording medium 90 such as an optical disk or a memory card and can reproduce the data.

The recording/reproducing part 46 has an encoding/decoding part 47, a media drive 48, and a recording/reproduction controller 49.

The encoding/decoding part 47 performs such a process in imaging pictures in which the imaged video data obtained in the camera part 42 is converted into the recording format for the recording medium 90. In addition, the encoding/decoding part 47 also converts the format of sound data. Moreover, such a processing form can be also considered that video and sound data are compressed in accordance with the MPEG (Moving Picture Experts Group) system or other compression systems and recorded on the recording medium 90.

The imaged video data (and sound data) processed in the encoding/decoding part 47 is supplied to the media drive 48, and recorded on the recording medium 90 mounted thereon.

In reproducing data recorded on the disk 90, video data (and sound data) reproduced by the media drive 48 is decoded in the encoding/decoding part 47.

Based on instructions from the system controller 41, the recording/reproduction controller 49 performs control over the process of the encoding/decoding part 47, the recording and reproduction operations done by the media drive 48, and data input and output.

Imaged video data obtained in the camera part 42 in imaging pictures, or video data reproduced from the recording medium 90 can be displayed on a viewfinder 60.

In conducting imaging pictures and in standby for imaging pictures, while the camera part 42 is outputting imaged video data, the imaged video data is supplied to a viewfinder driver 59.

The viewfinder driver 59 performs the operation of displaying video from imaged video data on the viewfinder 60 in accordance with instructions from the system controller 41. In addition, the viewfinder driver 59 superimposes and displays a character image in accordance with instructions from the system controller 41 thereon.

Moreover, in reproducing video data from the recording medium 90, video data that is reproduced and outputted by the media drive 48 and decoded in the encoding/decoding part 47 is supplied to the viewfinder driver 59. The viewfinder driver 59 performs the operation of displaying supplied video data and video from the character image to be superimposed on the viewfinder 60 in accordance with instructions from the system controller 41.

Therefore, a camera person can monitor pictures in standby (when confirming a subject) and in imaging pictures, check video contents recorded in the recording medium 90, or do simple editing, while viewing the viewfinder 60.

In addition, a display part 64 is provided separately from the viewfinder 60 to monitor pictures and to display reproduced video. A display driver 63 performs the operation of displaying videos from supplied video data and the character image to be superimposed on the display part 64 in accordance with instructions from the system controller 41.

In addition, in inputting characters, described later, the representation relating to character input, that is, the representation of inputted characters and conversion candidate character strings is also performed on the display part 64. The display driver 63 allows the display part 64 to represent inputted characters and conversion candidate character strings based on instructions from the system controller 41.

In addition, sound data reproduced from the recording medium 90 is subjected to D/A conversion in an audio driver 56, or subjected to signal processing such as filtering or amplification, and then outputted from a speaker part 57.

An external interface 50 is a block that inputs and outputs various items of data with the terminal 1 as an external device, and with the other devices such as a video editor and a storage device via cable or wireless communications. For example, current issue dictionary data can be received from the terminal 1 via communications between the external interface 50 and the external interface 35 of the terminal 1 shown in FIG. 2.

In addition, imaged video data can be supplied to the terminal 1 or the video editor via communications through the external interface 50.

A communicating part 51 is a block that performs network communications in a cable or wireless manner, for example. For instance, the communicating part 51 is formed of a modem, an Ethernet interface, and a mobile telephone interface. More specifically, the communicating part 51 is provided to also allow the imaging apparatus 10 to make access to the terminal 1 or the server apparatus 2 over the network 3 shown in FIG. 1.

The communicating part 51 may be incorporated in the imaging apparatus 10, or may be a discrete device to be connected to the imaging apparatus 10 for allowing the network communications of the imaging apparatus 10.

A ROM 53, a RAM 54, and a flash memory 55 are used as computation areas to store data and programs necessary for the system controller 41.

For example, the ROM 53 stores therein process programs and fixed data of the system controller 41. The RAM 54 is used to store temporary information and as a work area. The flash memory 55 stores therein various control coefficients.

Particularly, standard dictionary data and current issue dictionary data, described later, and practical dictionary data generated therefrom are stored in the flash memory 55, for example, and are referenced by the system controller 41.

A manipulating part 52 is prepared with various manipulating items for operating the imaging apparatus 10. More specifically, manipulating items for power operations, imaging operations, reproduction operations, zooming operations, various mode operations, edit operations, and character input operations are formed.

In accordance with the detection of user manipulations done by these manipulating items, the system controller 41 controls the individual blocks to do necessary operations.

For example, a power supply part 58 uses direct current power obtained from a built-in battery through a DC/DC converter, or direct current power generated from utility alternating power through a power source adopter to supply power supply voltage at necessary level to the individual circuit blocks. Turning power on/off by the power supply part 58 is controlled by the system controller 41 in accordance with the power operation by the manipulating part 52, described above.

### 3. A CURRENT ISSUE DICTIONARY DATA GENERATION PROCESS

Here, a current issue dictionary data generation process executed by the terminal 1 in the embodiment will be described.

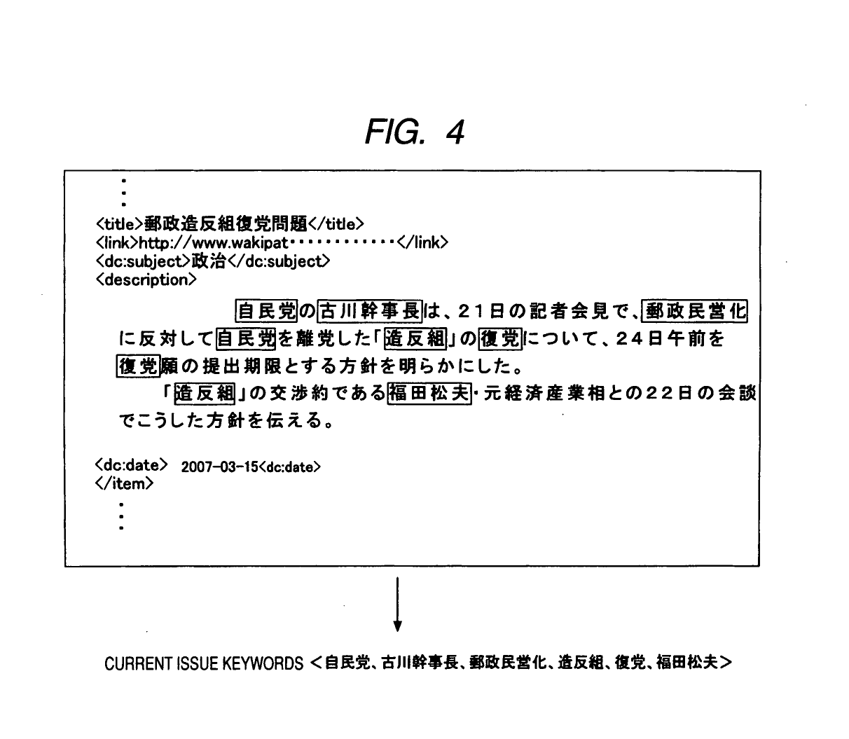

FIG. 4 shows exemplary news data acquired by the terminal 1 from the server apparatus 2 over the network 3. Here, as one example, it is considered that news data is based on an RDF (Resource Description Framework) file described in RSS (compliant to RDF Site Summary 0.9 or 1.0, Rich Site Summary 0.91, or Really Simple Syndication 0.92 or 2.0).

The acquired information has information about a title, a destination link, a subject, an article, a date, and an item.

For example, this news data has descriptions whose genre is political news. Then, the following are described in the news data; the title <title> is [symbol] [symbol] (a word of nine kanji characters represented by input of) YUUSEIZOUHANNGUMIHUKUTOUMONNDAI (the issue of reconverting defector members regarding the reforms of Posts and Telecommunications in English)”, the destination link <link> is a certain URL, the genre <dc:subject> is “politics”, the article <description> is the descriptions shown in the drawing, and the date <dc:date> is “2007-3-15”.

For example, in the terminal 1, generates current issue dictionary data is separately generated depending on the genres of “politics”, “economics”, “sports”, and “entertainment”. Then, in generating current issue dictionary data of the genre politics, the RDF file distributed as political news as shown in FIG. 4 is used.

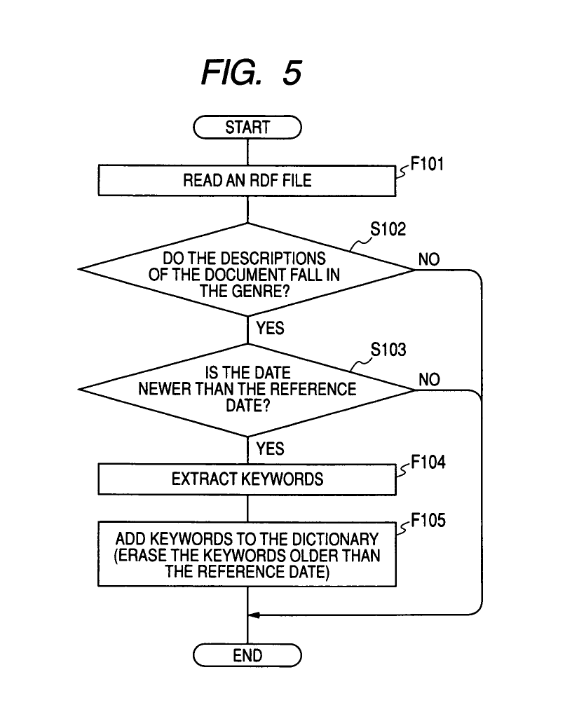

FIG. 5 shows the current issue dictionary data generation process. The process shown in FIG. 5 is the process operation executed by the CPU 21 of the terminal 1 in accordance with the program stored in the memory 23.

First, in Step F101, the CPU 21 reads an RDF file. In other words, the CPU 21 reads data in the RSS descriptions shown in FIG. 4 as news data distributed from the server apparatus 2.

In Step F102, the CPU 21 determines whether the descriptions of the document fall in the genre of current issue dictionary data to be generated this time. For example, in the case in which current issue dictionary data relating to politics is generated, the CPU 21 determines whether the genre falls in news data of “politics”.

This determination is a process that the column <dc:subject> shown in FIG. 4 is referenced to confirm whether the descriptions of the document fall in politics here. Then, if it is determined that the descriptions of the document fall in politics, the process goes to Step F103.

In Step F103, the CPU 21 determines whether the date of the RDF file is newer than a reference date. The RDF file is acquired from the server apparatus 2, and the file is updated everyday. On this account, in order to reference to the descriptions on the date with a criterion to some extent or above, the column <dc:date> shown in FIG. 4 is referenced to execute the determination process of the date. The reference date is one day, three days, or a week before the current date and time. In other words, it is the reference date that restricts news subjects to the latest date and time, the news subjects from which character strings to be registered as current issue dictionary data are extracted.

In Step F103, if it is determined that the date of the read news data is newer than the reference date, the process goes to Step F104, and the CPU 21 extracts current issue keywords.

In other words, in this case, the CPU 21 extracts the words of current issues relating to politics. The keywords of current issues are determined in such a way that morphological analysis, the determination of a part of speech of each of the words, and the comparison of the registered words of standard dictionary data are performed for determination depending on the results. For example, it can be considered that words frequently appear, words not registered in standard dictionary data, words with lower priorities, and proper nouns are the keywords of current issues.

For in stance, in the case in which news data shown in FIG. 4 is read, the following are extracted as current issue keywords from text data described as <description>: [symbol] (a word of three kanji characters represented by input of) JIMINNTOU (the Liberal Democratic Party of Japan in English)”, [symbol] (a word of five kanji characters represented by input of) HURUKAWAKANNJITYOU (Chief secretary HURUKAWA in English)”, [symbol] (a word of five kanji characters represented by input of) YUUSEIMINNEIKA (privatization of Posts and Telecommunications in English)”, [symbol] (a word of three kanji characters represented by input of) ZOUHANNGUMI (defector members in English)”, [symbol] (a word of two kanji characters represented by input of) HUKUTOU (reconversion in English)”, and [symbol] (a person's name of four kanji characters represented by input of) HUKUDAMATUO (a person' name MASTUO HUKUDA in English)”.

Subsequently, in Step F105, the CPU 21 additionally registers the current issue keywords extracted this time to current issue dictionary data held at this point in time. In addition, the CPU 21 erases old current issue keywords registered in current issue dictionary data. For example, the current issue keywords registered at an older point in time than the reference date are erased.

With this processing, the terminal 1 generates the latest current issue dictionary data all the time, for example, every time when reading news data distributed from the server apparatus 2 every day in the form in which old character strings are erased and new character strings are added to current issue dictionary data.

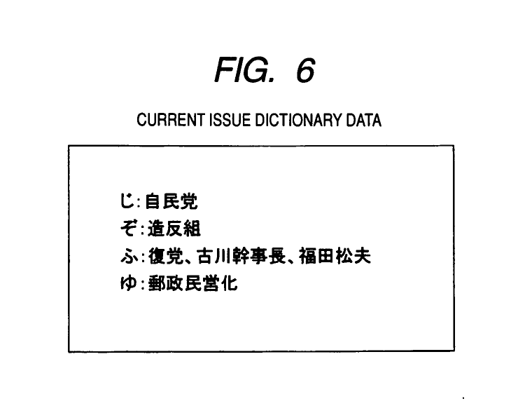

FIG. 6 shows exemplary items of current issue dictionary data generated in accordance with the process shown in FIG. 5. For example, the extracted current issue keyword is registered as a conversion candidate character string corresponding to the beginning character. In addition, here, among character strings registered in current issue dictionary data, only the words extracted from the news data shown in FIG. 4 are shown.

For example, to a character [symbol] (a hiragana character represented by input of) JI”, the current issue keyword [symbol] JIMINNTOU” corresponds for registration, to a character [symbol] (a hiragana character represented by input of) ZO”, the current issue keyword [symbol] ZOUHANNGUMI” corresponds for registration, to a character [symbol] (a hiragana character represented by input of) HU”, the current issue keywords [symbol] HUKUTOU, [symbol] HURUKAWAKANNJITYOU, and [symbol] HUKUDAMATUO” correspond for registration, and to a character [symbol] (a hiragana character represented by input of) YU”, the current issue keyword [symbol] YUUSEIMINNEIKA” corresponds for registration. In addition, as corresponding to the hiragana character [symbol] HU”, three current issue keywords, [symbol] HUKUTOU”, [symbol] HURUKAWAKANNJITYOU”, and [symbol] HUKUDAMATUO”, are extracted. In this manner, to the character to which a plurality of current issue keywords is extracted, some considerations of the order of candidates may be given. For example, since the frequency of appearance of the current issue keyword [symbol] HUKUTOU” is the highest in news data, the current issue keyword [symbol] HUKUTOU” is registered as the first candidate. Naturally, the order of extraction, the order of a set of hiragana characters, or a random order may be possible.

For example, as discussed above, in the current issue dictionary data, such keywords of current issues are registered that include word and proper nouns that are generally unlikely to be a conversion candidate, as words having a relatively small possibility of registration in the standard dictionary.

In addition, here, the example is discussed that current issue dictionary data of the genre politics is generated. It is sufficient to perform similar processes also in the case of generating current issue dictionary data of the other genres. For example, in the case of generating current issue dictionary data for sports, in Step F102, it is determined whether the document descriptions of the read RDF file relate to sports.

Moreover, such a scheme may be possible in which no genres are grouped for current issue dictionary data such as politics and sports, and words used as words relating to current issues are registered as current issue dictionary data for all genres. In this case, the process step in Step F102 is unnecessary.

In addition, here, current issue keywords are extracted from the RDF file. However, not restricted to the RDF file, HTML (Hyper Text Markup Language) files, XML (eXtensible Markup Language) files, and files including various other items of text data can be used. Furthermore, broadcasting data such as text broadcasting may be used.

### 4. A PRACTICAL DICTIONARY DATA GENERATION PROCESS

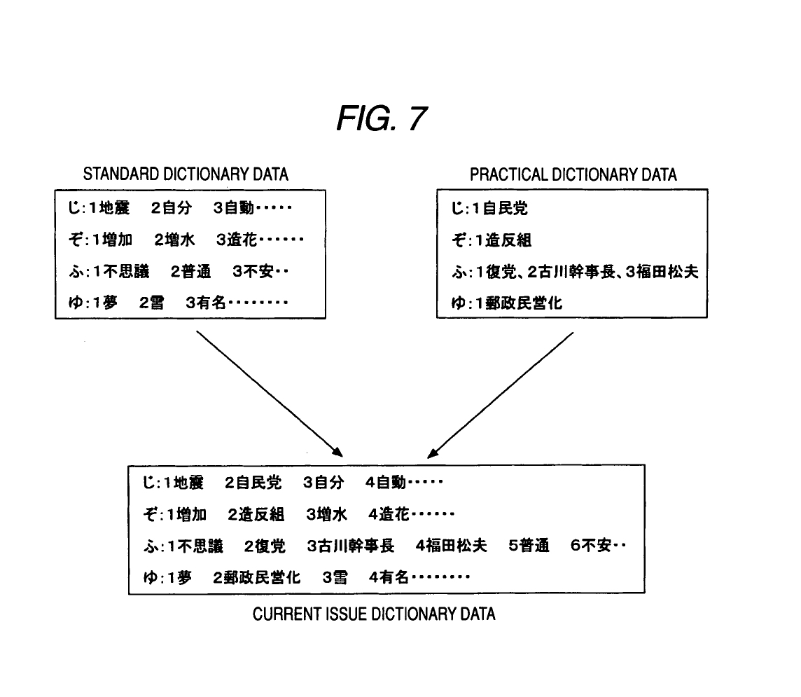

Next, a practical dictionary data generation process will be described with reference to FIG. 7.

For example, the imaging apparatus 10 takes the current issue dictionary data generated in the terminal 1, and stores the data in the flash memory 55.

In the imaging apparatus 10, standard dictionary data is stored in advance in the flash memory 55. In taking the latest current issue dictionary data therein, the imaging apparatus 10 combines the standard dictionary data with the current issue dictionary data to generate practical dictionary data that is actually used for prediction conversion.

FIG. 7 schematically shows practical dictionary data that is generated by combining standard dictionary data with current issue dictionary data.

Here, for explanation, on standard dictionary data, only hiragana characters [symbol] JI”, [symbol] ZO”, [symbol] HU”, and “ [symbol] YU” are shown as the same characters as those shown in the current issue dictionary data in FIG. 6.

For example, in the standard dictionary data shown in the drawing, as corresponding to the hiragana character “ [symbol] JI”, conversion candidate character strings are in turn registered as follows: “1. [symbol] (a word of two kanji characters represented by input of) JISINN (earthquake in English)”, “2. [symbol] (a word of two kanji characters represented by input of) JIBUNN (myself in English)”, and “3. [symbol] (a word of two kanji characters represented by input of) JIDOU (automatic in English)”, and so on. In addition, as corresponding to the hiragana character [symbol] ZO”, the following are registered: “1. [symbol] (a word of two kanji characters represented by input of) ZOUKA (increase in English)”, “2. [symbol] (a word of two kanji characters represented by input of) ZOUSUI (flooding in English)”, and “3. [symbol] (a word of two kanji characters represented by input of) ZOUKA (artificial flower in English)”. As corresponding to the hiragana character [symbol] HU”, the following are registered: “1. [symbol] (a word of three kanji characters represented by input of) HUSIGI (wonder in English)”, “2. [symbol] (a word of two kanji characters represented by input of) HUTUU (ordinary in English)”, and “3. [symbol] (a word of two kanji characters represented by input of) HUAN (anxiety in English)”. As corresponding to the hiragana character [symbol] YU”, the following are registered: “1. [symbol] (a word of a kanji characters represented by input of) YUME (dream in English)”, “2. [symbol] (a word of a kanji characters represented by input of) YUKI (snow in English)”, and “3. [symbol] (a word of two kanji characters represented by input of) YUUMEI (famous in English)”.

Then, the standard dictionary data is combined with the current issue dictionary data to obtain practical dictionary data.

More specifically, in the practical dictionary data, for example, as corresponding to the hiragana character [symbol] JI”, the following words are registered as conversion candidate character strings: [symbol] JISINN”, [symbol] JIBUNN”, and [symbol] JIDOU” in the standard dictionary data and [symbol] JIMINNTOU” in the current issue dictionary data.

In addition, as corresponding to the hiragana character [symbol] ZO” in the practical dictionary data, [symbol] ZOUKA”, [symbol] ZOUSUI”, and [symbol] ZOUKA” registered in the standard dictionary and [symbol] ZOUHANNGUMI” in the current issue dictionary data are registered as conversion candidate character strings.

In other words, practical dictionary data is dictionary data in which words registered in both of standard dictionary data and current issue dictionary data are registered as conversion candidate character strings.

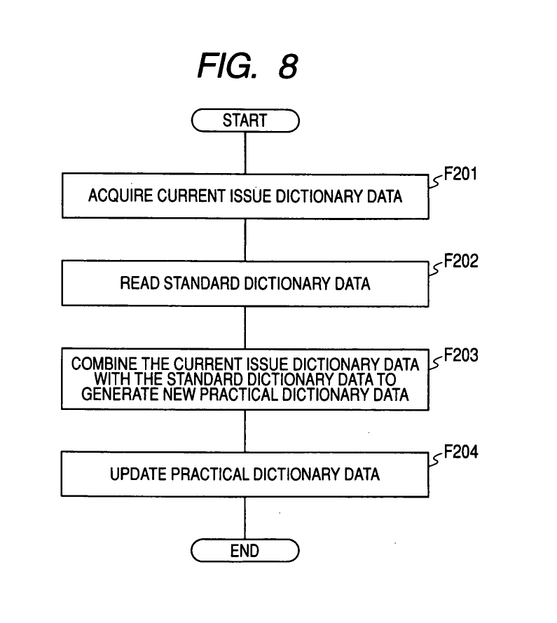

FIG. 8 shows a practical dictionary data generation process. This process can be considered to be the process operation done by the system controller 41 of the imaging apparatus 10 in accordance with the program stored in the ROM 53, for example.

First, in Step F201, the system controller 41 acquires current issue dictionary data. In other words, the system controller 41 acquires current issue dictionary data as shown in FIG. 6 from the terminal 1 side, and stores the data in the flash memory 55, for example, as well as decompresses the data on the RAM 54 for processing.

Subsequently, in Step F202, the system controller 41 reads standard dictionary stored in the flash memory 55, and decompresses the data on the RAM 54.

In Step F203, the system controller 41 combines conversion candidate character strings registered in the current issue dictionary data with the standard dictionary data to generate new practical dictionary data. In other words, the system controller 41 combines the conversion candidate character strings in current issue dictionary data with the conversion candidate character strings registered with respect to the individual characters of the standard dictionary to generate practical dictionary data as shown in FIG. 7.

Then, in Step F204, the system controller 41 updates the practical dictionary data. In other words, the system controller 41 rewrites the practical dictionary data stored in the flash memory 55 for use to new practical dictionary data generated this time.

By the process steps described above, the practical dictionary data is generated/updated. After that, the system controller 41 of the imaging apparatus 10 can use practical dictionary data including the latest current issue keywords to process prediction conversion in inputting characters.

In addition, by this process, the conversion candidate character strings in current issue dictionary data are combined with the conversion candidate character strings in standard dictionary data. At this time, various schemes can be considered at which rank a current issue keyword has to be inserted as the priorities of the conversion candidate character strings.

As one example, as shown in practical dictionary data in FIG. 7, such a scheme can be considered in which the conversion candidate character strings in current issue dictionary data are inserted at the second rank within the priorities of the conversion candidate character strings in standard dictionary data.

More specifically, as corresponding to the hiragana character [symbol] JI” in the practical dictionary data, the character string [symbol] JIMINNTOU” in the current issue dictionary data is inserted as the second candidate subsequent to the character string [symbol] JISINN” registered in the standard dictionary as the first candidate, and the character strings are registered in the order of candidates “1. [symbol] JISINN, 2. [symbol] JIMINNTOU, 3. [symbol] JIBUNN, 4. [symbol] JIDOU and so on”.

In addition, as corresponding to the hiragana character [symbol] ZO” in the practical dictionary data, the character string [symbol] ZOUHANNGUMI” in the current issue dictionary data is inserted as the second candidate subsequent to the character string [symbol] ZOUKA” registered in the standard dictionary as the first candidate, and the character strings are registered in the order of candidates “1. [symbol] ZOUKA, 2. [symbol] ZOUHANNGUMI, 3. [symbol] ZOUSUI, 4. [symbol] ZOUKA and so on”.

In addition, as corresponding to the hiragana character [symbol] HU” in the practical dictionary data, three current issue keywords [symbol] HUKUTOU”, [symbol] HURUKAWAKANNJITYOU”, and [symbol] HUKUDAMATUO” in the current issue dictionary data are combined as the second, the third, and the fourth candidate subsequent to the character string [symbol] HUSIGI” registered in the standard dictionary as the first candidate, and the character strings are registered in the order of candidates “1. [symbol] HUSIGI, 2. [symbol] HUKUTOU, 3. [symbol] HURUKAWAKANNJITYOU, 4. [symbol] HUKUDAMATUO, 5. [symbol] HUTUU, 6. [symbol] HUAN and so on”.

In addition, as corresponding to the hiragana character [symbol] YU” in the practical dictionary data, the character string [symbol] YUUSEIMINNEIKA” in the current issue dictionary data is inserted as the second candidate subsequent to the character string [symbol] YUME” registered in the standard dictionary as the first candidate, and the character strings are registered in the order of candidates “1. [symbol] YUME, 2. [symbol] YUUSEIMINNEIKA, 3. [symbol] YUKI, 4. [symbol] YUUMEI and so on”.

In consideration of the current issue keywords registered in the current issue dictionary data that are possibly words with high use frequency in the imaging apparatus 10 for reporting, for example, desirably, the rank of registration of these words is relatively higher priorities in the practical dictionary data.

On the other hand, in the standard words registered in the standard dictionary, the character string of high use frequency is selected as the character string of the first candidate. In addition, in consideration that the order of candidates is changed in the learning function, it can be thought that the character string of the first candidate is also the word currently used.

In consideration of these points, in the practical dictionary data, it can be considered to be adequate that the character string of the first candidate in the standard dictionary data is left as the first candidate, and after that, the conversion candidate character strings in current issue dictionary data may have the ranks of relatively higher priorities. For example, it is suitable that the current issue keywords are arranged from the second candidate as described above.

In addition, of course, various ways of arranging the order of candidates can be thought. Such schemes may be thought in which the conversion candidate character string in current issue dictionary data is arranged as the first candidate, and in which the conversion candidate character strings in current issue dictionary data and the conversion candidate character strings in standard dictionary data are alternately arranged.

### 5. A CHARACTER INPUT PROCESS

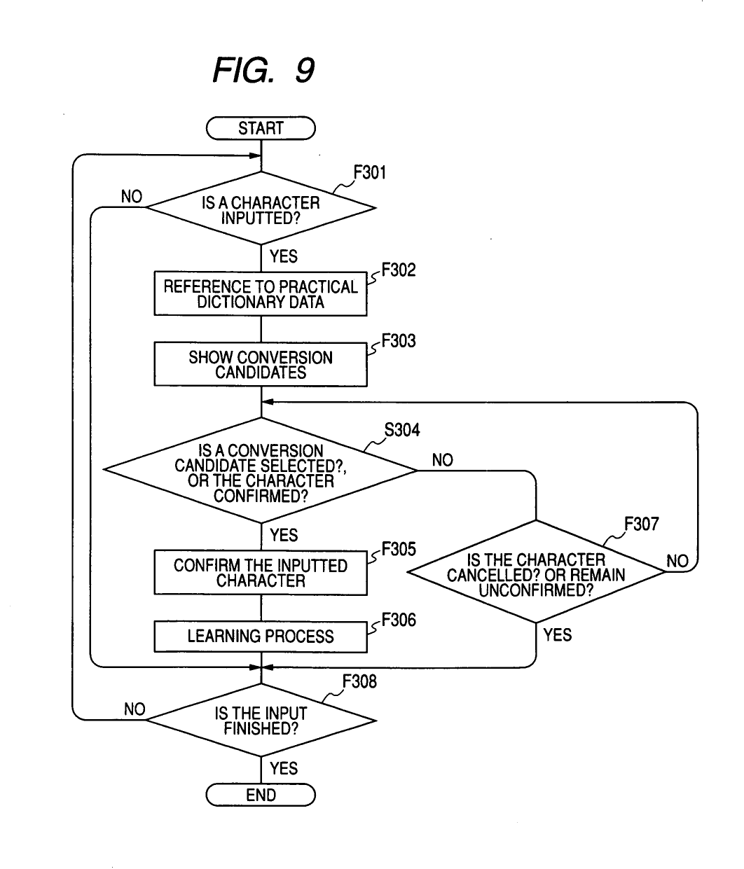

Next, a process in performing the character input operation in the imaging apparatus 10 will be described with reference to FIG. 9. The process shown in FIG. 9 is a process executed by the system controller 41 of the imaging apparatus 10 after practical dictionary data is generated (updated). In addition, the system controller 41 continuously and repeatedly executes the process steps of Step F301 to Step F308 shown in FIG. 9.

First, in Step F301, the system controller 41 determines whether a character input is made. More specifically, the system controller 41 determines whether a user inputs a character through the manipulating part 52.

Then, if the system controller 41 determines in Step F301 that a character input is made, the process goes to Step F302, and then the system controller 41 references to practical dictionary data. In other words, in the case in which the user inputs a certain character, the system controller 41 references to practical dictionary data, and reads conversion candidate character strings corresponding to the inputted character.

In Step F303, the system controller 41 allows the display part 64 to display the conversion candidate character strings read out of the practical dictionary data. For example, in the case in which a hiragana character [symbol] HU” is inputted in the previous Step F302, the following conversion candidates are obtained from the practical dictionary data shown in FIG. 7: “1. [symbol] HUSIGI, 2. [symbol] HUKUTOU, 3. [symbol] HURUKAWAKANNJITYOU 4. [symbol] HUKUDAMATUO, 5. [symbol] HUTUU, 6. [symbol] HUAN, and so on”. Thus, the system controller 41 allows the display part 64 to display these registered conversion candidate character strings.

The system controller 41 confirms user manipulation in Step F304 and F301. The user makes such a manipulation that the user selects a specific conversion candidate character string listed as the conversion candidate, or the user selects no conversion candidate character string to keep a character inputting (for example, the user inputs the next character), or the user selects no conversion candidate character string to confirm the current inputted character, or the user cancels the input operation to end the process.

If the user selects a specific conversion candidate character string listed as the conversion candidate, the system controller 41 advances the process from Step F304 to F305 to confirm the inputted character. More specifically, the system controller 41 confirms the selected conversion candidate character string as the inputted characters. For example, in the case in which the user selects the conversion candidate character string “3. [symbol] HURUKAWAKANNJITYOU” among the conversion candidate character strings shown with respect to the input of the hiragana character [symbol] HU”, the system controller 41 confirms this [symbol] HURUKAWAKANNJITYOU” as the inputted characters.

In addition, also in the case in which the user selects no conversion candidate character string to confirm the current inputted character, the system controller 41 advances the process from Step F304 to F305 to confirm the inputted character. More specifically, the system controller 41 confirms the selected conversion candidate character string as the inputted character. For example, in the case in which the user selects no conversion candidate character string shown after the input of a hiragana character [symbol] HU” and then confirms the input, the system controller 41 confirms the input of the hiragana character [symbol] HU”.

The system controller 41 confirms the inputted character in Step F305, and then performs the learning process in Step F306. For example, in the case in which a conversion candidate character string is selected, the arranging order is updated on practical dictionary data so as to put the conversion candidate character string to a higher priority. In addition, particularly in the case in which the user selects no conversion candidate character string to confirm a character, such a process may be performed that the character is added as a conversion candidate character string to the practical dictionary data (and further to the standard dictionary data).

In the case in which the user selects no conversion candidate character string to keep a character inputting, for example, the user first inputs a hiragana character [symbol] HU” and then enters a character [symbol] (a hiragana character represented by input of) KU”, the system controller 41 advances the process from Step F301 to F308, F307 and F302. In this case, in Steps F302 and F303, the system controller 41 references to practical dictionary data and shows the conversion candidate character strings for the unconfirmed hiragana characters [symbol] HUKU”.

For example, the following are read out of the practical dictionary data and shown: conversion candidate character strings [symbol] (a word of two kanji characters represented by input of) HUKUSYUU (review a lesson in English)”, [symbol] HUKUTOU”, [symbol] (a word of two kanji characters represented by input of) HUKUSYUU (revenge in English)”, and so on.

In the case in which the user cancels the inputted character, the system controller 41 advances the process from Step F307 to F308. Although not shown in detail in FIG. 9, for example, the unconfirmed character at that point in time is erased on the display.

The process described above is repeated until the user finishes inputting characters and the system controller 41 determines that the character input is finished in Step F308, whereby character input using practical dictionary data is performed.

Then, as discussed above, the fact that a conversion candidate character string registered in the practical dictionary data is selected to allow character input, which means that current issue keywords that are the conversion candidate character strings in current issue dictionary data can be efficiently inputted with the use of prediction conversion.

The learning process in Step F306 is adequately performed to further improve character input efficiency.

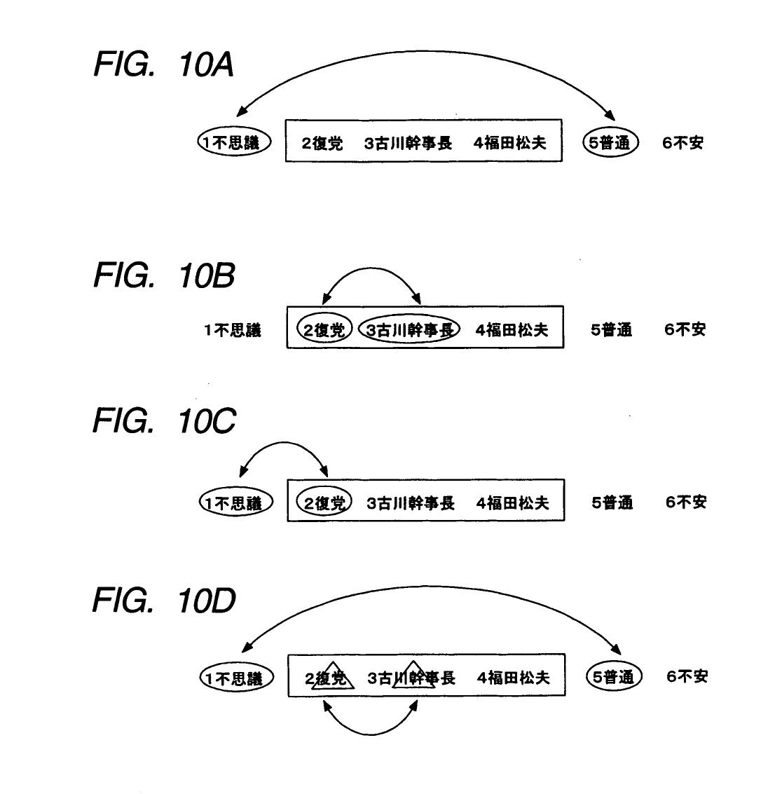

Here, since the practical dictionary data includes the conversion candidate character strings in standard dictionary data and the conversion candidate character strings in current issue dictionary data, examples shown in FIGS. 10A to 10D can be considered to be learning processes for the priorities.

FIG. 10A is an example showing that the learning targets for the priorities are only the conversion candidate character strings in standard dictionary data.

Here, for a hiragana character [symbol] HU”, three conversion candidate character strings in current issue dictionary data [symbol] HUKUTOU”, [symbol] HURUKAWAKANNJITYOU”, and [symbol] HUKUDAMATUO” are registered as the second, the third, and the fourth candidate, in addition to the conversion candidate character strings in standard dictionary data.

In the case in which a character string [symbol] HUTUU” is selected, which is registered as the fifth candidate in the practical dictionary data, a standard word [symbol] HUSIGI”, which is registered as the first candidate in the practical dictionary data, is replaced by the standard word [symbol] HUTUU”.

On the other hand, in the case in which any one of character strings [symbol] HUKUTOU”, [symbol] HURUKAWAKANNJITYOU”, and [symbol] HUKUDAMATUO” is selected and confirmed, the learning process is not performed in particular.

As described above, one example of the learning process can be considered that only the conversion candidate character strings in standard dictionary data are learning targets relating to the priorities. Since the ranks of the conversion candidate character strings in current issue dictionary data are fixed, the efficiency is improved in the case in which text frequently using the words of current issues is inputted.

FIG. 10B is an example in the reverse manner showing that the learning targets for the priorities are only the conversion candidate character strings in current issue dictionary data.

In the case in which character strings [symbol] HUSIGI” and [symbol] HUTUU” are selected, the ranks are not changed in accordance with the learning process in particular. On the other hand, although the second, the third, and the fourth candidate are the conversion candidate character strings in current issue dictionary data, for example, in the case in which the third candidate [symbol] HURUKAWAKANNJITYOU” is selected among them, the rank thereof is replaced with the rank of the second candidate [symbol] HUKUTOU”. In other words, in the case in which n strings of the conversion candidate character strings in current issue dictionary data are registered, the current issue keywords are from the second candidate to the (n+1)th candidate, and the selected conversion candidate character string is moved to the upper rank within the range from the second candidate to the (n+1)th candidate.

In the case in which a particular word is frequently inputted, the character input efficiency is more improved than the example show in FIG. 10A.

FIG. 10C is an example showing that the conversion candidate character strings in standard dictionary data and the conversion candidate character strings in current issue dictionary data are not distinguished for changing their priorities.

For example, in the case in which the second candidate [symbol] HUKUTOU” is selected, the first candidate [symbol] HUSIGI” is replaced with the second candidate [symbol] HUKUTOU” to set the second candidate [symbol] HUKUTOU” to the first candidate. In the case in which the words of current issues are not used frequently, the learning process is conducted without distinguishing the sets of dictionary data as discussed above, whereby input efficiency is improved.

FIG. 10D is an example showing that the priorities of the conversion candidate character strings in standard dictionary data and the conversion candidate character strings in current issue dictionary data are changed within the range of the order established first time.

In the case in which n strings of the conversion candidate character strings in current issue dictionary data are registered, the current issue keywords are from the second candidate to the (n+1)th candidate. In the case in which a conversion candidate character string in current issue dictionary data is selected, the selected conversion candidate character string is moved to the upper rank within the range from the second candidate to the (n+1)th candidate.

In addition, although the first candidate and the (n+2)th candidate and below are the conversion candidate character strings in standard dictionary data, in the case in which a conversion candidate character string of standard dictionary data is selected, the ranks are replaced in order of the first candidate, and the (n+2)th candidate and below.

For example, in the case in which the third candidate [symbol] HURUKAWAKANNJITYOU” is selected, the rank thereof is replaced with the rank of the second candidate [symbol] HUKUTOU”. In addition, in the case in which the fifth candidate [symbol] HUTUU” is selected, the rank thereof is replaced with the rank of the first candidate [symbol] HUSIGI”. The learning process is conducted within the individual sets of dictionary data, whereby it can be expected that character input efficiency is more improved than the example in FIGS. 10A and 10B.

As the examples discussed above, various schemes can be considered for the process of replacing priorities in the learning process.

Of course, not only the scheme in which a single choice is made to replace the rank, but also such a scheme can be considered that the number of choices is counted to reflect the cumulative count value in the ranks, for example.

### 6. ADVANTAGES AND MODIFICATIONS ACCORDING TO THE EMBODIMENT

According to the embodiment discussed above, in the terminal 1, current issue dictionary data is generated in which character strings as current issue keywords are registered. In addition, in the imaging apparatus 10, current issue dictionary data is combined with standard dictionary data to generate practical dictionary data. Then, in the imaging apparatus 10, the practical dictionary data is used in inputting characters, whereby a character string as a current issue keyword can be inputted through prediction conversion.

Thus, the improvement of character input efficiency can be intended for the character strings in current issues, which is preferable in such an apparatus that has many opportunities of inputting the character strings in current issues. For example, when characters of titles and comments are inputted for video files in news reporting, the character strings in current issues are often used. Therefore, the current issue keywords can be inputted through prediction conversion to significantly improve the efficiency of character input operation, which is remarkably preferable.

In addition, the embodiment of the invention is not restricted to the embodiment discussed so far, for which various modifications can be considered.

For example, in the embodiment, it is configured in which the terminal 1 generates current issue dictionary data. However, current issue dictionary data may be generated on the imaging apparatus 10 side. More specifically, this scheme may be possible in which the imaging apparatus 10 receives news data from the server apparatus 2, and the system controller 41 of the imaging apparatus 10 performs the process shown in FIG. 5 to generate current issue dictionary data.

In other words, this configuration may be possible that the imaging apparatus 10 is a dictionary generating apparatus that generates current issue dictionary data according to the embodiment of the invention.

In addition, in the embodiment, it is configured in which practical dictionary data is generated by the process shown in FIG. 8 in the imaging apparatus 10. However, this scheme may be possible in which practical dictionary data is generated on the terminal 1 side, and the practical dictionary data is passed to the imaging apparatus 10. More specifically, this is the example that the process shown in FIG. 8 is conducted in the CPU 21 of the terminal 1.

Furthermore, this configuration may be possible the terminal 1 corresponds to a character input apparatus according to the embodiment of the invention. In other words, this scheme may be possible in which the terminal 1 generates current issue dictionary data (or practical dictionary data), and uses the current issue dictionary data (or the practical dictionary data) for conducting the prediction conversion process in inputting characters.

In addition, in the embodiment, the discussion is made so far that the imaging apparatus 10 corresponds to a dictionary generating apparatus that generates practical dictionary data, and a character input apparatus according to the embodiment of the invention. However, it is without saying that apparatuses other than the imaging apparatus 10 (the video camera) can be the dictionary generating apparatus and the character input apparatus according to the embodiment of the invention. For example, to every apparatus such as a digital still camera, a cellular telephone, a personal computer, a PDA (Personal Digital Assistant), and a video editor, the embodiment of the invention can be adapted with regard to character input.

In addition, it is configured in which the character input apparatus such as the imaging apparatus 10 uses practical dictionary data including current issue keywords to conduct the prediction conversion process. However, current issue dictionary data may be used to conduct the prediction conversion process.

It should be understood by those skilled in the art that various modifications, combinations, sub-combinations and alterations may occur depending on design requirements and other factors insofar as they are within the scope of the appended claims or the equivalents thereof.

What is claimed is:

1. A dictionary data generating apparatus comprising:
an acquiring part configured to acquire a current issue keyword from inputted information including a current issue keyword; and
a generating part configured to generate current issue dictionary data for prediction conversion based on the current issue keyword acquired by the acquiring part.

2. The dictionary data generating apparatus according to claim 1,
wherein the acquiring part acquires a current issue keyword for every genre from the inputted information, and
the generating part generates the current issue dictionary data from the current issue keyword for every genre.

3. The dictionary data generating apparatus according to claim 1,
wherein the generating part combines the current issue dictionary data with standard dictionary data that is generated based on a standard word to generate practical dictionary data for prediction conversion.

4. The dictionary data generating apparatus according to claim 3,
wherein the generating part generates the practical dictionary data so that a current issue keyword in current issue dictionary data is inserted into a predetermined order of candidates as an order of candidates for character input.

5. A character input apparatus comprising:
a conversion candidate acquiring part configured to reference to practical dictionary data for prediction conversion including a current issue keyword to acquire one or a plurality of conversion candidate character strings in response to a character input;
a presenting part configured to present a conversion candidate character string acquired by the conversion candidate acquiring part; and
an input confirmation processing part configured to confirm an input character string from a conversion candidate character string presented by the presenting part in response to manipulation input.

6. The character input apparatus according to claim 5,
wherein the practical dictionary data for prediction conversion includes current issue dictionary data that is generated based on a current issue keyword and standard dictionary data that is generated based on a standard word, and
the character input apparatus includes a learning processing part configured to change an order of arranging the input character strings on the practical dictionary data for prediction conversion to which the conversion candidate acquiring part references in accordance with an input character string confirmed by the input confirmation processing part.

7. The character input apparatus according to claim 6,
wherein only when the input character string is included in the conversion candidate character strings in standard dictionary data, the learning processing part changes an order of arranging the input character string.

8. The character input apparatus according to claim 6,
wherein when the input character string is included in conversion candidate character strings in the current issue dictionary data, the learning processing part changes an order of arranging the input character string within a range established in advance as conversion candidate character strings in the current issue dictionary data, and
when the input character string is included in conversion candidate character strings in the standard dictionary data, the learning processing part changes an order of arranging the input character string within a range established in advance as conversion candidate character strings in the standard dictionary data.

9. A dictionary data generating method comprising the steps of:
acquiring a current issue keyword from inputted information including a current issue keyword; and
generating current issue dictionary data for prediction conversion based on an acquired current issue keyword.

10. The dictionary data generating method according to claim 9,
wherein the generating step further comprising the step of combining the current issue dictionary data with standard dictionary data that is generated based on a standard word to generate the practical dictionary data for prediction conversion.

11. A character input method comprising the steps of:
referencing to practical dictionary data for prediction conversion including a current issue keyword to acquire one or a plurality of conversion candidate character strings in response to a character input;
presenting the acquired conversion candidate character string; and
confirming an input character string from the presented conversion candidate character string in response to manipulation input.

12. The character input method according to claim 11,
wherein the practical dictionary data for prediction conversion includes current issue dictionary data that is generated based on a current issue keyword and standard dictionary data that is generated based on a standard word, and
the character input method further comprising the step of: changing an order of arranging the confirmed input character string on the practical dictionary data for prediction conversion.

13. The character input method according to claim 12,
wherein in the changing step, only when the confirmed input character string is included in the conversion candidate character strings in standard dictionary data, an order of arranging the input character string is changed.

14. The character input method according to claim 12,
wherein in the changing step, when the confirmed input character string is included in conversion candidate character strings in the current issue dictionary data, an order of arranging the input character string is changed within a range established in advance as conversion candidate character strings in the current issue dictionary data, and
when the confirmed input character string is included in conversion candidate character strings in the standard dictionary data, an order of arranging the input character string is changed within a range established in advance as conversion candidate character strings in the standard dictionary data.
